(19) United States
(12) Patent Application Publication
(10) Pub. No.: US 2005/0170173 A1
(43) Pub. Date: Aug. 4, 2005

(54) Sheet for application of erasable print

(76) Inventors: Michel Coguelin, Besse sur Braye (FR); David Charles Bray, Wakall (GB)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/503,092

(22) PCT Filed: Jan. 29, 2003
(86) PCT No.: PCT/FR03/00273

(30) Foreign Application Priority Data
Feb. 1, 2002 (FR) 02/01227

(51) Int. Cl. B32B 27/00; B32B 27/30; B32B 23/04; B32B 29/00

(52) U.S. Cl. 428/340; 428/500; 428/522; 428/532; 428/537.5

(57) ABSTRACT

This invention relates to a printing-writing sheet comprising a medium for which at least one face has a surface on which at least one type of dry erasable marking can be made, the said surface being formed by a composition comprising a film-forming agent and a release agent not containing any coating pigments. It also relates to a reusable article comprising at least the said sheet.

This invention relates to re-usable printing-writing sheets with a surface on which dry erasable markings, and possibly also permanent markings, can be made.

A large number of sheets have been described, usually paper that has been made transparent, for applications in which the objective is to be able to erase or correct a Xerox type printout for which the image is the result of a toner being fixed by heat. In particular, they have been described in patents U.S. Pat. No. 5,006,389, U.S. Pat. No. 5,102,730 and U.S. Pat. No. 5,145,749. Markings are erased by slight abrasion of the surface, therefore, one disadvantage of these sheets is that their surface is modified since erasing may, for example, destroy its gloss or quickly deteriorate its capability of being erased at the same location several times.

Other sheets like those described in patent U.S. Pat. No. 5,024,898 may be marked with dry erasable inks that can be eliminated simply by wiping the surface with a piece of fabric or non-woven material. These sheets, papers, or plastic films comprise a resin layer on the surface cured by an EBC (Electron Beam Curing) process.

With the widespread development of office printers, large quantities of paper are consumed even though some of the information marked on this paper does not need to be kept, and much paper is used for simple draft printouts; these paper sheets could be reused several times if office paper were made available on which laser printout and/or ink jet printouts could be erasable.

Moreover, there are many applications in which it would be desirable to completely erase or simply correct handwritten markings. Examples include sheets for school children's exercise books, agendas or crossword type games, colouring books for children. Examples of other applications involve more rigid articles such as marker boards, information display panels such as price panels, panels marking the source of food in shops or on market places, wall coatings or interactive panels enabling a direct written expression.

Moreover, some systems are currently under development to relate a writing surface and a writing means capable of electronically processing writing on this surface.

For example, the MIMIO company has developed a system with an interactive bar and ultrasound markers to connect writing of markings, for example on a whiteboard, and for computer control of this system.

According to another example, the Swedish ANOTO Company has developed and patented a new system relating an electronic pen to a so-called digital paper on which a raster can be seen in infrared for the pen micro-camera that films the writing movement. The pen microprocessor records and transcribes the markings into digital data and sends these data to a computer to store and/or process them, or for example to send them by fax. This type of paper is described particularly in International patent application WO 0126032.

In both cases, it would be advantageous if the surface on which the markings are made were erasable, so that it can be reusable and/or easily enable the required corrections or modifications, for example for creative applications.

All these applications require a surface on which the following can be marked at the same time:

conventional permanent printing, for example such as offset printout for the grid of the pages, the composition of agendas, crossword tables, etc., and

markings made with dry erasable pencils or markers, that can be eliminated simply by wiping.

It is also important that erasability should not apply solely to black ink, but should be valid at least for the primary colours (blue, red and green).

For good use of these potential articles, it would also be desirable for accidental markings made with permanent ink to be erased in the same way as on traditional marker boards, by adding a dry erasable marking over the permanent marking, and then wiping everything off. Good erasability of markings made with a ballpoint pen would also be useful, by using an eraser.

Therefore, this surface must be capable firstly of receiving permanent markings and secondly temporary markings that remain in place, in other words, that are not easily erased under normal working conditions but can still be erased with little effort.

Finally, since all these applications are aimed at large volume markets for which cost is an overriding factor, it is important that the new sheets be made from traditional raw materials, using conventional manufacturing processes.

Therefore, the purposes of this invention are to solve prior problems while satisfying existing needs, industrial requirements and cost issues, and also to broaden erasability and provide new erasable articles.

The main purpose of the invention is to propose new erasable printing-writing sheets made using conventional methods and for which the surface can receive at least one type of dry erasable marking, that can be erased simply by making a manual effort with a piece of fabric or non-woven material, an erasing brush or any other moderate rubbing means, without alteration (erosion or abrasion) of the said surface during erasing.

A secondary purpose of the invention is to propose new erasable sheets obtained in a conventional manner and for which the surface can receive permanent writing and printing and dry erasable marking and printing by applying a simple manual effort using a piece of fabric or non-woven material, an erasing brush, or any other moderate rubbing means without alteration of the said surface during erasing.

The Applicant proposes to achieve this using sheets comprising a medium for which at least the surface of one of the two faces was coated with a composition suitable for the required erasing.

The invention thus provides sheets for printing-writing comprising a medium for which at least one face has a surface on which at least one type of dry erasable markings can be made, the said surface being formed by a composition, called an erasable composition, comprising a film-forming agent and a release agent not containing any coating pigments.

The role of the film-forming agent is to reduce porosity at the support surface of the sheet, and the role of the release agent is to adjust the compromise between the required printability and erasability.

Preferably, the release agent comprises a reactive group in order to reduce the sensitivity of the said film-forming agent to humidity when this agent is very hydrophilic.

Preferably, the said film-forming agent, according to the invention, is chosen from among organic polymers and mineral film-forming agents.

Preferably, the said organic polymers are chosen from among polymers used as binders in the paper industry, particularly among native starches and degraded starches, polyvinylic alcohols (PVA) with a high rate of hydrolysis.

Native starches are starches extracted from natural compounds comprising starch. Degraded starches are native starches partially depolymerised by chemical or physical action. Examples of degraded starches include low viscosity dextrin marketed by the ROQUETTE company under the name Tackidex®.

The said mineral agents are preferably chosen from among sodium silicates. Sodium silicates like those marketed in an aqueous solution by the INEOS SILICAS company under the name CRYSTAL® can be used.

Preferably, release agents according to the invention are chosen from among Alkyl ketene dimers, polyolefin waxes, chlorine complexes called Werner complexes, reactive acrylic copolymers and calcium stearate.

Alkyl Ketene Dimers (AKD) that can be used include those marketed by the RAISIO CHEMICALS company under the Alcet® trade name. Polyolefin waxes that can be used include the polyethylene emulsion marketed by the DANIEL PRODUCTS Company under the name SLIP-AYD®. Werner complexes that can be used include those marketed by the SEPPIC company under the name Montacell®. Reactive acrylic copolymers that can be used include those marketed by the SYNTHRON company under the name AM123 R Prox®, this polymer being an ethyl acrylate and methyl methacrylate copolymer with acrylic and N-methylolacrylamide motifs as the reactive groups.

Depending on the application of the sheet and the nature of the sheet medium, the dry weight of erasable composition deposited per square meter and the proportion of the film-forming agent/release agent by dry weight may be variable.

According to one particular case of the invention, the weight of the layer of the said composition is between 0.5 and 10 g/m² of dry weight per face, and preferably between 1 and 3 g/m².

More particularly, the proportion of the film-forming agent/release agent by dry weight is between 98/2 and 50/50, and preferably between 80/20 and 95/5.

The composition may also possibly include additives normally used in the papermaking industry such as anti-foam agents, rheology modifying agents, a pH regulating agent, a colouring agent, etc.

For example, a sheet medium refers to a plastic film or a fibre sheet, but preferably it will be paper based on cellulose fibres, slightly or very refined, and/or synthetic or mineral fibres and therefore obtained through papermaking route. The flexible or rigid nature and the grammage of the said medium depend on application of the article. If it is required to create a flip chart, the medium will be flexible and the grammage will be low, whereas if it is required to make a marker board, the reverse will be true. The medium may possibly be coloured.

The surface condition of the sheet medium, before being coated with the erasable composition, is of prime importance, therefore if this medium is a paper it is important that it shall be machine-glazed or calender-finished and/or pre-coated. Preferably, the medium is pre-coated by one or several pigmented undercoats traditionally used for making printing-writing paper and possibly soft calender-finished paper. These coats are based on binders and coating pigments such as a mix of a copolymer (styrene-butadiene) used in a stable aqueous emulsion (latex) and calcium carbonate pigments.

In one particular case, the support of the sheet is a natural tracing paper obtained by thorough refining of cellulose fibres, possibly coloured, fluorescent or comprising particles with optical effects like those now used for printing or as a cover sheet, this type of paper having a closed surface condition very suitable for the invention.

The composition making the paper erasable will be deposited by a conventional coating process known in the paper industry in which a sheet that may be a paper sheet or a plastic film is covered by a uniform layer of an aqueous sauce, for which the constituents are then fixed and dried by heat. Preferably, the coating process is the so-called steel blade process because it enables a high manufacturing speed.

In order to achieve a suitable surface condition, it is preferable that a conventional super-calendering or soft-calendering operation should take place during or at the end of manufacturing before or after coating the erasable composition. The sheet is therefore such that its surface is calender-finished under and/or on the erasable composition. Depending on the sheets and their applications, that control the quality level and the market volume, it has been found that it is wise to add the erasable coat during or outside the steps for manufacturing conventional coated printing-writing paper.

The preferred two sequences are as follows:

1/Process performed on the conventional line: the sheet medium is made with a preliminary printing-writing coat and the erasable coat is then deposited by online coating, and the sheet obtained is then calendered.

2/Process performed on a coater off the conventional line: the erasable coat is deposited by coating the erasable coat on the support that is a glossy conventional coated printing-writing paper, in other words a coated and calender-finished paper.

In another process according to the invention, the pre-coat and the erasable coat can be added simultaneously using a curtain coating device.

According to a particular case of the invention, the sheet is characterized by the fact that there is a means of permanent positioning of the erasable markings, in particular a grid or a frame of dots, on the surface of the said medium, either before or after being coated with the said erasable composition. More particularly, the dots in the grid can be positioned by infrared radiation and enable processing of markings using an electronic system.

The invention also relates to a reusable article comprising the previously described printing-writing sheet. The article may be a whiteboard, a marker board, a poster, a school exercise book, a colouring book, an agenda, or a games book. Optionally, a rigid article may be made by pasting two flexible sheets together, or a flexible sheet onto a rigid background.

The article may also be a set of mobile sheets made according to the invention, the sheets possibly but not necessarily being repositionable, and that can be assembled by different chemical or mechanical means (for example adhesive, screw or bolts). In one particular case of the invention, the said assembly forms a flip chart.

The invention will be better understood after reading the following non-limitative examples that illustrate the invention, with various media and for different types of markings. Permanent printing tests are made using a 204H offset machine made by Man Roland with the Optima® ink series by the COATES LORILLEUX company and the Kromoplast® ink series made by the BRANCHER company.

Markings made with dry erasable inks (with a solvent based on alcohol and/or on methyl isobutylcetone and/or on ethylacetate) may be made using the nine felt pens or black commercial markers described below and their equivalents in blue, red and green:

BIC VELLEDA ref 1721,

BIC VELLEDA, ref 1741,

PILOT,

DE VISU ALBAPLAN 800,

REYNOLDS EFFA'SEC,

ESQUISSE,

GUILBERT NICEDAY DM42,

STAEDTLER 351,

PENTEL MAXIFLO.

Erasing tests are done manually using a tissue. They are marked from 0 “does not erase” to 3 “complete erasing with no visible trace at 30 centimetres and with no surface erosion”, with intermediate marks for the erased marking equal to 1 “marking still legible at 1 metre” and 2 “no visible trace at 1 meter”. The results are given in the tables in the form of the average of 9 individual marks for the test with black ink, or 27 individual marks for the test for blue, red, green inks, with the lowest individual mark given between parentheses. A high individual mark means that the sheet works equally well with a wide range of pens and markers.

The ballpoint pen test may possibly be carried out with a black BIC® CRISTAL ballpoint pen using the same erasing test principle described above.

Xerox printouts are denoted “Xerox print” in the tables, and are made on a Xerox 332D photocopier, the laser printouts are made on a Hewlett Packard Laserjet 6P printer, and solid ink jet colour printouts (denoted “Inkjet print” in the tables) on Xerox Tektronic Phaser 850; the print motif is a 7×22 millimetres grid.

Erase tests of these Xerox, laser and inkjet printouts are also performed manually with a tissue; they are marked A “does not erase or with difficulty”, B “printout too fragile for working manipulations” or C “the printout bonds but can be erased without deterioration (erosion) of the surface and without leaving any trace”.

Examples 1a to 1c, 2a and 2b, 3a and 3b, 4a and 4b, 5a to 5c, are coated on a laboratory steel blade coater at a speed of 30 metres per minute. Examples 7a and 7b are carried out using the same process on a high-speed pilot coater. Examples 6a to 6c are made on a laboratory coater using the Meyer bar system.

### EXAMPLES 1a TO 1c

Sheets 1a to 1c are made using a calender-finished gloss coated paper medium with a grammage of 170 g/m², including 27 g/m² of a global printing-writing coat on one face.

A global coat means a coat formed from several coats.

The deposited dry weight of the erasable composition on this medium, is 1.5 g/m² per face.

Chrome complexes called Werner complexes marketed by the SEPPIC company under the name Montacell S® were used as the release agent for all the examples.

A polyvinyl alcohol (PVA) with a hydrolysis ratio of 98% was used as the film-forming polymer for examples 1a and 1b, while dextrin marketed by the ROQUETTE company under the name Tackidex® C172 was used for example 1c.

Table 1 shows the number of parts by dry weight of film-forming polymer and reactive release agent for each sheet, for 100 dry parts of erasable composition and their marks given during the tests.

The sheets thus coated were checked without being calendered again.

The behaviour of the three sheets under dry erasable inks is excellent; film-forming polymer and contents must be chosen as a function of the type of printing for which erasability is required.

### EXAMPLES 2a AND 2b

The same erasable composition was used as in 1b, with 1 g/m² of dry weight being deposited on a 170 g/m² medium which is a coated semi-mat paper with a 26 g/m² global printing-writing coat on each face. In the case of example 2b, this medium is pre-calender-finished before coating with the erasable composition.

Table 2 contains the characteristics and tests results.

The pre-calendered sheet 2b has an excellent erasability compromise. Moreover, this sheet 2b can be offset printed using Optima series ink with an excellent print rendering (high gloss colour, no mottling defect) and once dry this printout is permanent, in other words it is not altered when markings made with dry erasable ink are erased.

### EXAMPLES 3a AND 3b

The erasable composition in 1b is still used, but this time the medium is a tracing paper with a grammage of 110 g/m².

The characteristics and test results are given in table 3.

### EXAMPLES 4a AND 4b

The reactive release agent is PROX® AM 123R used at a content of 10 parts by dry weight to 90 parts by dry weight of a PVA 4/98 (hydrolysis ratio 98%) film-forming polymer.

The erasable composition is coated with a dry coating weight of 1.5 g/m² per face for the two examples. In the case of example 4a, the medium is the same 170 g/m² gloss coated paper as in example 1a. In the case of example 4b, the support is a 75 g/m² pre-coated paper with a 7 g/m² printing-writing pre-coat on each face. Sheet 4b is calender-finished after the erasable composition has been coated.

The characteristics and test results are given in Table 4.

### EXAMPLES 5a To 5c

Sheets 5a to 5c are made using the same support as example 1a, with a deposit of 3 g/m² dry of an erasable composition comprising the following for 100 parts by dry weight:

potato starch converted by enzymation, as the film-forming polymer;

the ALCET® 4102 Alkyl ketene dimer made by the RAISIO CHEMICALS company as the reactive release agent, used at the content given in Table 5.

The characteristics and test results are given in table 5.

### EXAMPLES 6a To 6c

The mineral film-forming agent used in these examples is CRYSTAL® 0503 sodium silicate marketed in an aqueous medium with a solid content of 46%, by the INEOS SILICAS company (United Kingdom).

The release agent used is Alkyl ketene dimer (AKD) marketed by the EKA CHEMICALS company under the name Keydime® 22LQ, used alone for examples 6a and 6b, while for example 6c it is used mixed with polyethylene wax marketed by the DANIEL PRODUCTS (USA) and ELEMENTIS SPECIALITIES companies (Netherlands) under the name SLYP-AYD® SL 330 E, in the form of an aqueous emulsion with a 30% solid content.

The erasable composition is deposited at a rate of 8 g/m² dry, on the surface of a gloss calender-finished coated paper support with a grammage of 160 g/m², on which there is an 18 g/m² global printing-writing coat on each face.

Table 6 shows the nature and number of dry parts of release agent per 100 parts of erasable composition for each sheet, together with the test results.

As in examples 5a to 5c, a high content of Alkyl ketene dimer is not useful for dry erasable inks.

### EXAMPLES 7a AND 7b

The sheets in these examples were made at high speed under conditions similar to industrial reality.

The erasable composition is the same as for sheet 1b.

Sheet 7a is coated at a speed of 1,000 metres per minute, with a dry weight deposition of 1.4 g/m² per face on a support consisting of a gloss calender-finished coated paper with a grammage of 150 g/m², for which a global print-write coat of 26 g/m² is applied on each face.

In a second step, sheet 7a is offset printed with a grid motif using KROMOPLAST ink series.

Sheet 7b is coated at a rate of 500 meters per minute, with a dry weight of 1.6 g/m² deposited on the same pre-coated support as sheet 4b, and is finally calendered.

Sheet 7a is particularly suitable for flip chart applications using all dry erasable ink colours, even when printing above an offset print of a grid provided to guide writing.

Sheet 7b is multi-purpose. It is adapted to various office applications due to the erasability of solid laser and inkjet printouts, and moreover Xerox printouts remain erasable (level C) even after 10 passes/successive wipings of the same sheet in the photocopier. This sheet 7b is also suitable for use in schoolbooks, agendas and games books, due to its behaviour when handwritten markings are made on it, and because it can be offset printed with the OPTIMA ink series.

Finally, this sheet 7b, with the erasable composition deposited on only one of the two faces, may be pasted to another identical sheet (uncoated faces) to produce a rigid article such as a marker board.

Table 7 contains the characteristics and test results.

### GENERAL CONCLUSION

All examples presented satisfy at least the main purpose of the invention, in other words they provide new erasable sheets obtained in a conventional manner and with a surface that can be marked with all types of dry erasable markings, that are erased simply by applying a simple manual effort using a piece of fabric or non-woven material, an erasing brush or any other moderate rubbing means, without alteration (without erosion or abrasion) of the said surface during erasing. Some examples such as examples 2b and 7b satisfy higher standards about the erasability type and the resistance of permanent printing, and the sheets obtained can be used for a wide range of applications.

TABLE 1

| | Film- | | | | | | |
|---|---|---|---|---|---|---|---|
| | forming | Release | | | | | |
| Ex- | polymer | agent | Black | Ball point | Xerox | Laser | Inkjet |
| ample | (parts) | (parts) | markers | PEN | print | print | print |
| 1a | 95 | 5 | 3 | 3 | C | A | C |
| 1b | 90 | 10 | 3 | 0 | B | C | C |
| 1c | 90 | 10 | 3 | 0 | B | B | A |

TABLE 2

| | Pre- | Black | | | Inkjet |
|---|---|---|---|---|---|
| Example | calendering | markers | Xerox print | Laser print | print |
| 2a | No | 3 | B | C | A |
| 2b | Yes | 3 | C | C | C |

TABLE 3

| | Weight of | |
|---|---|---|
| | erasable coat | |
| Example | (g/m² per face) | Black markers |
| 3a | 3 | 2.8 (2) |
| 3b | 6.5 | 3 |

TABLE 4

| | Support | | |
|---|---|---|---|
| Example | grammage (g/m²) | Post-calendering | Black markers |
| 4a | 170 | No | 3 |
| 4b | 75 | Yes | 3 |

TABLE 5

| | Part of AKD by | | | |
|---|---|---|---|---|
| Example | dry weight | Black markers | Xerox print | Laser print |
| 5a | 6 | 3 | B | B |
| 5b | 13 | 2.7 (2) | B | B |
| 5c | 20 | 1.4 (1) | B | B |

TABLE 6

| | Release agent | | |
|---|---|---|---|
| Example | (parts) | Black markers | Laser print |
| 6a | AKD: 10 parts | 1.2 (1) | A |
| 6b | AKD: 20 parts | 0 | C |
| 6c | AKD: 10 parts | 2.1 (1) | C |
| | Polyethylene wax: 5 parts | | |

TABLE 7

| | Black | Colour | Ballpoint | Xerox | | Inkjet |
|---|---|---|---|---|---|---|
| Example | markers | markers | PEN | print | Laser print | print |
| 7a no grid | 2.8 (2) | — | 2 | C | B | A |
| 7a grid | — | 3 | — | — | — | — |
| 7b | 3 | 3 | 3 | C | C | C |

1. Printing-writing sheet comprising a medium for which at least one face has a surface on which at least one type of dry erasable markings can be made, wherein said surface is formed by a composition comprising a film-forming agent and a release agent not containing any coating pigments.

2. Sheet according to claim 1, wherein said film-forming agent is hydrophilic and said release agent comprises a reactive group with hydrophilic groups.

3. Sheet according to claim 1, wherein said film-forming agent is chosen from among organic polymers and mineral film-forming agents.

4. Sheet according to claim 3, wherein said organic polymers are chosen from among polymers used as binders in the paper industry.

5. Sheet according to claim 4, wherein said binders are chosen from among native starches, degraded starches, polyvinylic alcohols (PVA) with a high rate of hydrolysis.

6. Sheet according to claim 3, wherein said mineral film-forming agents are chosen from among sodium silicates.

7. Sheet according to claim 1, wherein said release agent is chosen from among Alkyl ketene dimers, polyolefin waxes, chlorine complexes called Werner complexes, reactive acrylic copolymers and calcium stearate.

8. Sheet according to claim 7, wherein said reactive acrylic copolymers are ethyl acrylate and methyl methacrylate copolymers with acrylic and N-methylolacrylamide motifs as the reactive groups.

9. Sheet according to claim 1, wherein the weight of the layer of he said erasable composition is between 0.5 and 10 g/m² of dry weight per face.

10. Sheet according to claim 1, wherein the proportion of the film-forming agent/release agent by dry weight is between 98/2 and 50/50.

11. Sheet according to claim 1, wherein said medium is chosen from among plastic films and fibre sheets.

12. Sheet according to claim 11, wherein the face of said medium, when it is a paper is machine-glazed or calender-finished and/or pre-coated, before being coated with the said erasable composition.

13. Sheet according to claim 12, wherein the surface of said medium comprises one or several pigmented undercoats, before being coated with said erasable composition.

14. Sheet according to claim 13, wherein said pigmented undercoat(s) and said erasable composition were added simultaneously using a curtain coating device.

15. Sheet according to claim 1, wherein the surface of said sheet is calender-finished under/or on the erasable composition.

16. Sheet according to claim 1, wherein the surface of said medium comprises a means of permanent positioning of the erasable markings, in particular a grid or a frame of dots either before or after being coated with the said erasable composition.

17. Sheet according to claim 16, the dots in the grid can be positioned by infrared radiation and enable processing of markings using an electronic system.

18. Reusable article comprising at least one printing-writing sheet according to claim 1.

19. Sheet according to claim 9, wherein the weight of the layer of the said erasable composition is between 1 and 3 g/m².

20. Sheet according to claim 10, wherein the proportion of the film-forming agent/release agent by dry weight is between 80/20 and 95/5.

21. Sheet according to claim 11, wherein said medium is chosen from among paper based on cellulose fibres, slightly or very refined, and/or synthetic or mineral fibres obtained through papermaking route.
